(19) United States
(12) Patent Application Publication
(10) Pub. No.: US 2015/0238385 A1
(43) Pub. Date: Aug. 27, 2015

(54) HITCHINS POST

(71) Applicant: Beverley Anne Hitchins, Smiths Falls (CA)

(72) Inventor: Beverley Anne Hitchins, Smiths Falls (CA)

(21) Appl. No.: 14/192,182

(22) Filed: Feb. 27, 2014

(51) Int. Cl. A61H 39/04

(52) U.S. Cl. CPC A61H 39/04

(57) ABSTRACT

The Hitchins Post is a self-manipulated pressure point tool. The tool is designed such that it can be mounted in several different ways to any flat surface. The primary function for this tool is to utilize the solid structure to which it is mounted against to allow the operator to self-apply force to the hard to reach areas such as the upper/middle back, providing deep pressure point massage therapy. The tool is made to be portable and versatile such that it can be used at any time or place to relieve stress and strain such as on an airplane or at work using the chair or nearby wall as your mounting surface. The tool was designed to relieve the pain associated with Fybromyalgia, Myofascial, as well as other back and muscle related pains. The pressure point massage is accomplished using two strategically placed and sized balls which are separated by specific distances to accommodate different users.

The Hitchins Post is an Active Therapeutic Device. It is a most effective tool when mounted against an unmoving flat surface such as a chair, floor or wall. When mounted, The Hitchins Post is a hands free tool which provides the ability to self-apply the appropriate pressure for a deep tissue massage. This pressure and location of the massage is completely self-manipulated so that the used can control how much and where relief is applied. It however, is also capable of being used in the palm of your hand as well to apply pressure to any muscle. The tool being small enough to carry in a purse is ideal for long travel times and the discomfort associated with being stuck in one position for hours. This is also true of many workplaces. Having such a tool to provide relief from Fybromyalgia, Myofascial as well as other back, neck and muscle related pains where you need it, when you need it will help reduce the need for pain medications and professional physical therapies.

The substitute specification contains no new material.

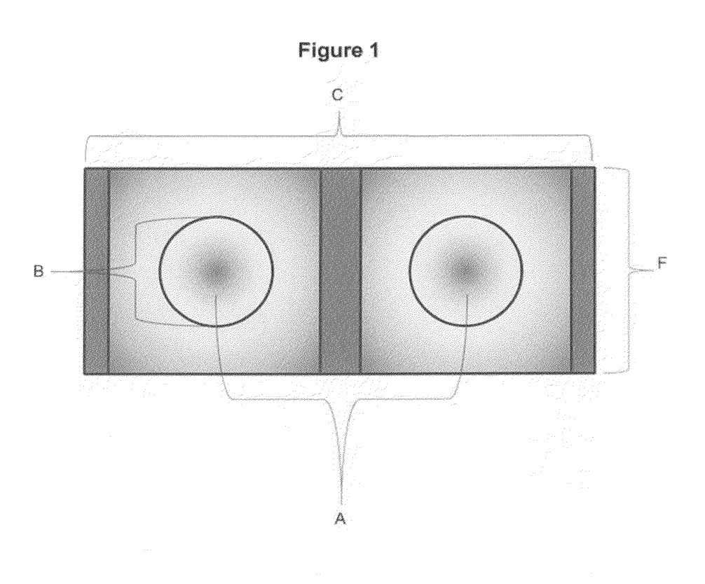

FIG. 1—Top view looking down, showing the main width of the Base (C) 100 mm and 145 mm depending on size by (F) 60 mm. 6 Sizes are available as shown in (A) 40 mm-90 mm The distance between the center of each ball. (B) Shows the size of the round balls at 32 mm each to which there are 2 balls on each Hitchins Post Tool.

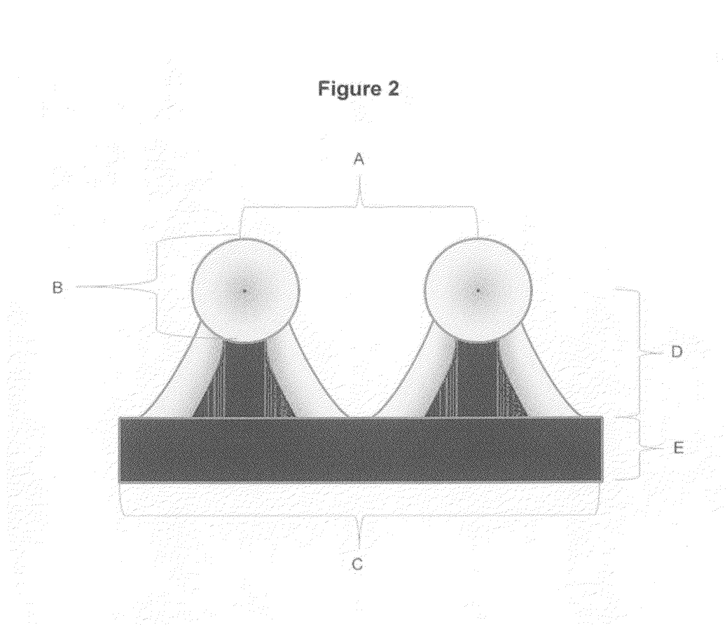

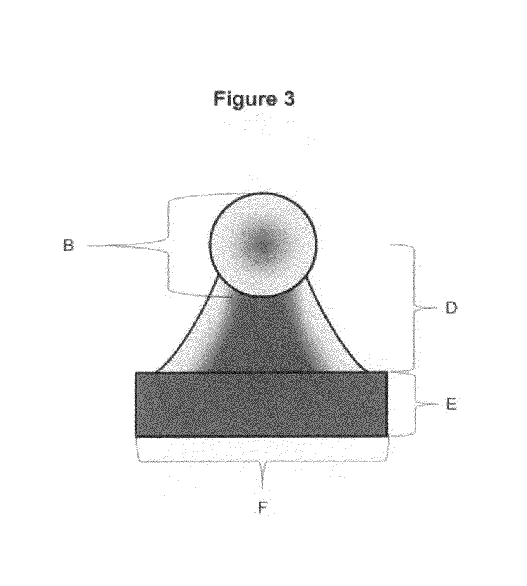

FIG. 2—Side view of total height of tool (B, D and E) for a total of 76 mm. (B) shows the height of the ball positions into (D) the Ball Mounts at 40 mm and (E) the Base at 20 mm. This view also shows the maximum and minimum distance between the (B) balls of 40 mm minimum-90 mm maximum depending on size of tool.

Sizes range from Mini Small/40 mm, Mini Medium/50 mm, Mini Large/60 mm, Small/70 mm, Medium/80 mm and Large/90 mm. This view also shows how the fabrication stage will alter the (B) balls into (D) ball mounts. (cont'd Page 2)

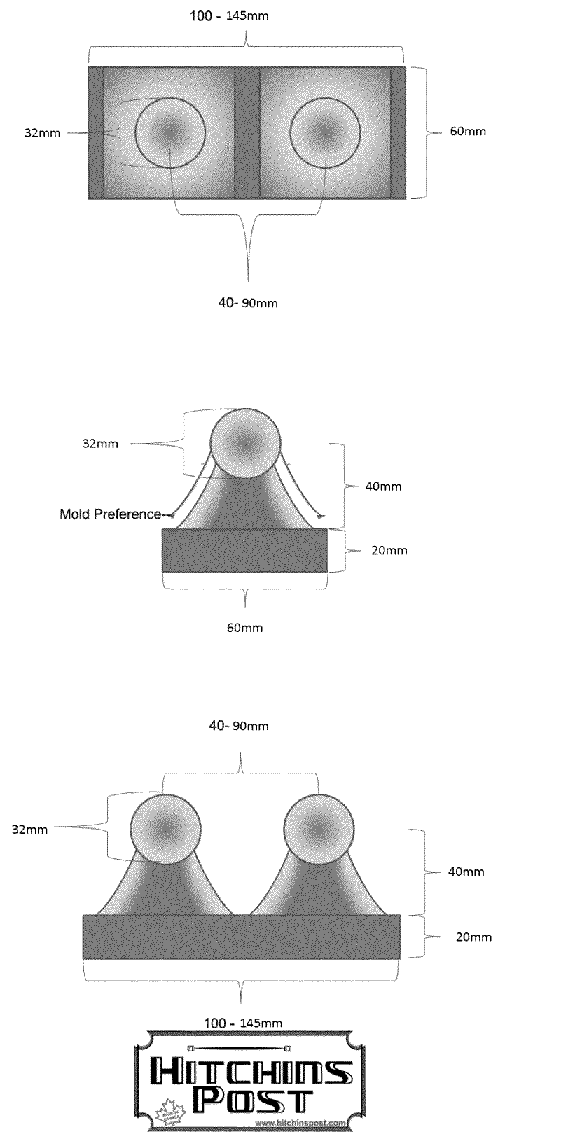

FIG. 3—End view of the tool shows the thickness of the main base end (E) at 20 mm as well as the width of the (F) base end at 60 mm. This view only shows the positioning of 1-(B) Ball and 1-(D) Ball Mount.

1. I claim the pressure point tool as shown; Re: Canadian Patent Pending #2809247—Mar. 1, 2013. The Hitchins Post is a self-manipulated pressure point tool. The tool is designed as such, that it can be mounted in several different ways, to any flat surface. The primary function for this tool is to utilize the solid structure to which it is mounted against, to allow the operator to self-apply force to the hard to reach areas such as upper/middle back, providing deep pressure point massage therapy. The tool is made to be portable and versatile such that it can be used at any time or any place to relieve stress and strains such as on an Airplane or at work using a chair or nearby wall as your mounting surface. The tool was designed to relieve pain associated with Fybromyalgia, Myofascial as well as other back and muscle related pains. The pressure point massage is accomplished using 2 (two) strategically placed and sized balls which are separated by specific distances to accommodate different users.
